(19) United States
(12) Patent Application Publication
(10) Pub. No.: US 2006/0008616 A1
(43) Pub. Date: Jan. 12, 2006

(54) Insulation material including extensible mesh material from fibrous material

(76) Inventors: Patrick Dean, Granville, OH (US); Anthony L. Rockwell, Pickerington, OH (US)

Correspondence Address: OWENS CORNING, 2790 COLUMBUS ROAD, GRANVILLE, OH, 43023, US

(21) Appl. No.: 11/024,081

(22) Filed: Dec. 28, 2004

Related U.S. Application Data
(63) Continuation-in-part of application No. 10/889,442, filed on Jul. 12, 2004.

(51) Int. Cl. B32B 3/12

(52) U.S. Cl. 428/117; 442/61; 442/85; 442/152; 442/164; 442/172; 442/178; 442/179; 442/180; 442/381; 442/414; 428/116

(57) ABSTRACT

A web or panel of insulation is provided that includes an extensible web of fibrous material that is configured to provide a series of openings in the expanded web. The openings within the web are filled with insulation to provide a batt or panel of thermal or acoustical insulation. More specifically, the present invention relates to insulation filled extended fibrous webs that are suitable for use as thermal or acoustical insulation in a building structure, as a partition or panel or as thermal or acoustical insulation in a motor vehicle.

### CROSS REFERENCE TO RELATED APPLICATIONS

This application is a continuation-in-part of U.S. patent application Ser. No. 10/889,442 filed Jul. 12, 2004, the content of which is incorporated by reference in its entirety.

### TECHNICAL FIELD AND INDUSTRIAL APPLICABILITY OF THE INVENTION

The present invention relates generally to a web of insulation that is configured to provide a series of openings in an expanded web, where the openings within the extended web are filled with insulation to provide a batt or panel of thermal or acoustical insulation. More specifically, the present invention relates to an insulation filled extended fibrous web that is suitable for use as thermal or acoustical insulation in a building structure, as a partition or panel, or as thermal or acoustical insulation in a motor vehicle.

### BACKGROUND OF THE INVENTION

Perforated nonwoven fabrics of fibrous material are well known in the art. Representative examples include U.S. Pat. No. 5,714,107 to Levy et al.; U.S. Pat. No. 4,615,671 to Bernal; and U.S. Pat. No. 3,864,198 to Jackson. In each of these prior art patents, the fibrous material is slit or cut and then subjected to stretching to provide a honeycomb web or open cell structure.

Unfortunately, stretching the material to form the honeycomb or open cellular structure leads to the tearing of a significant number of the fiber-to-fiber bonds thereby reducing the strength and integrity of the resulting material. Further, the friability of the material is also increased by the tearing of so many bonds. Thus, erection of the honeycomb web or cellular material in accordance with prior art methods leads to significant detrimental results.

The present invention relates to an insulation material that includes a honeycomb web precursor and a method of producing an insulation filled honeycomb web where the precursor is erected by folding rather than stretching. Accordingly, the resulting product has improved fiber-to-fiber bond integrity and exhibits reduced friability when compared to prior art cellular structures.

### SUMMARY OF THE INVENTION

In accordance with the purposes of the present invention as described herein, an insulation batt that includes an extensible honeycomb web is provided. The honeycomb web precursor includes a body of fibrous material with a series of slits that extend between opposed surfaces of the body of fibrous material. The web may then be filled with an appropriate insulation material to form the insulation material of the present invention. Advantageously, the body is extensible into a web or honeycomb construction primarily by bending or flexing the fibers rather than extending the fibers or the axially displacing the fibers.

More specifically, the fibrous body may include thermoplastic fibers, thermosetting fibers, glass fibers, metallic fibers, ceramic fibers or combinations thereof. The fibers may be single component, or multi-component. The multi-component fibers may be sheath core, side by side, islands in the sea or any other suitable multi-component configuration. In accordance with one aspect of the present invention, the honeycomb web may be formed of any suitable fiber including but not limited to polyolefin fibers, polyamide fibers, polyester fibers, polypropylene fibers, polyvinyl chloride fibers, polyethylene fibers, nylon fibers, rayon fibers, polyethylene terephthalate fibers, polyvinyl acetate fibers, polybutylene terephthalate fibers, melamine fibers, acrylic fibers, visil fibers, aramid fibers, glass fibers, metal fibers, basalt fibers, mineral fibers, carbon fibers, graphite fibers, cotton fibers, sisal fibers, and mixtures thereof.

The fibrous insulation that fills the interstices of the honeycomb web may be formed of any suitable fiber including, but not limited to polyolefin fibers, polyamide fibers, polyester fibers, polypropylene fibers, polyvinyl chloride fibers, polyethylene fibers, nylon fibers, rayon fibers, polyethylene terephthalate fibers, polyvinyl acetate fibers, polybutylene terephthalate fibers, melamine fibers, acrylic fibers, visil fibers, aramid fibers, loosefill glass fibers, metal fibers, basalt fibers, mineral fibers, carbon fibers, graphite fibers, cotton fibers, sisal fibers, and mixtures thereof.

The fibrous body typically includes both inexpansible portions at the peripheral edges and a medial expansible portion. The inexpansible portion is substantially continuous and the expansible portion may include a series of slits. In one embodiment, the inexpansible and expansible portions alternate across the body. In another embodiment the inexpansible portion forms the lateral edges of the fibrous body while the expansible portion forms the interior of the fibrous body.

Still more specifically describing the invention, the series of branched slits at least partially nest within one another. In one possible embodiment, each of the branched slits is substantially Y-shaped. Adjacent branched slits define an expansion rib. Each expansion rib includes a first segment and a second segment. The first segment is connected to the second segment by a first flexible hinge. The first segment is connected to one of the inexpansible portions by a second flexible hinge and the second segment is connected to another of the inexpansible portions by a third flexible hinge.

In accordance with one aspect of the present invention, a honeycomb web precursor is provided that includes a body of fibrous material that includes alternating rows of slits. In another aspect of the invention, the slits may intersect with openings having extension slits to define a four-way flexible hinge at a convergence of adjacent slits and the openings such that when the fibrous body is expanded, a series of interstitial openings is formed.

In accordance with yet another aspect of the present invention, a method is provided for producing a honeycomb web of fibrous material, subsequently expanding the web to form interstitial spaces and filling those interstices with fibrous insulation. The method includes making a series of slits in a body of fibrous material to define multiple ribs such that the body may be expanded. The ribs may then be expanded to form a honeycomb web defining open interstices between the ribs. The honeycomb web may then be filled with an insulation material having desired thermal insulating, acoustical insulating and/or structural properties. The insulation panel may then be fixed in the expanded state by thermally bonding the thermoplastic fibers, setting a binder in insulation material or any other suitable method of adhering the fibers one to another. The panel may then be sealed by the application of a facer material to one or preferably both sides of the panel.

The expanding or erecting of the honeycomb web is preferably achieved by bending or flexing the fibers rather than by stretching the body, by extending the fibers, or axially displacing the fibers. Accordingly, the integrity of fiber-to-fiber bonds is maintained for maximum material strength and to minimize the friability of the resulting erected structure.

A motor vehicle panel of a honeycomb web of fibrous material that includes a series of geometric shaped openings may be formed. A partition of a honeycomb web of fibrous material that includes a series of geometric shaped openings with a facer attached to one side may also be formed. A second facer may be attached to an opposing surface to provide a sandwiched structure with the web positioned between the first and second facers. In accordance with yet another aspect of the present invention, one or both of the facers may be decorative facers. The facers may be formed of any suitable material, such as, natural or polymeric fibrous material, foils, paper, fiberglass mats, or polymer sheets or films such as ester vinyl acetate, polyvinyl chloride, rubber materials and highly filled sheets or films. The facer may also include a reinforced web. The second facing layer may then be connected to the second face. That second facing layer may be constructed from materials similar to those of the first facing layer.

### BRIEF DESCRIPTION OF THE DRAWINGS

The accompanying drawings incorporated in and forming a part of the specification, illustrate several aspects of the present invention and together with the description serve to explain certain principles of the invention. In the drawings:

FIGS. 1a and 1b are top plan views respectively illustrating a first embodiment of the honeycomb web precursor and the folded or erected honeycomb web of a first embodiment of the present invention;

FIGS. 2a and 2b are top plan views illustrating, respectively, an unerected honeycomb web precursor and an erected honeycomb web of a second embodiment of the present invention;

FIG. 3 is a cross sectional view illustrating another possible embodiment of the present invention where the spaces, openings or interstices of the web material are filled with a material selected for its insulating or other properties;

FIG. 4 is yet another embodiment of the present invention where the honeycomb web includes a first facing layer and an insulation material;

FIG. 5 is a schematic side elevation view illustrating the insulation panel of the present invention including flanges; and

FIG. 6 is yet another alternative embodiment where the honeycomb web includes opposing facing layers.

Reference will now be made in detail to the present preferred embodiment of the invention, an example of which is illustrated in the accompanying drawings.

### DETAILED DESCRIPTION AND PREFERRED EMBODIMENTS OF THE INVENTION

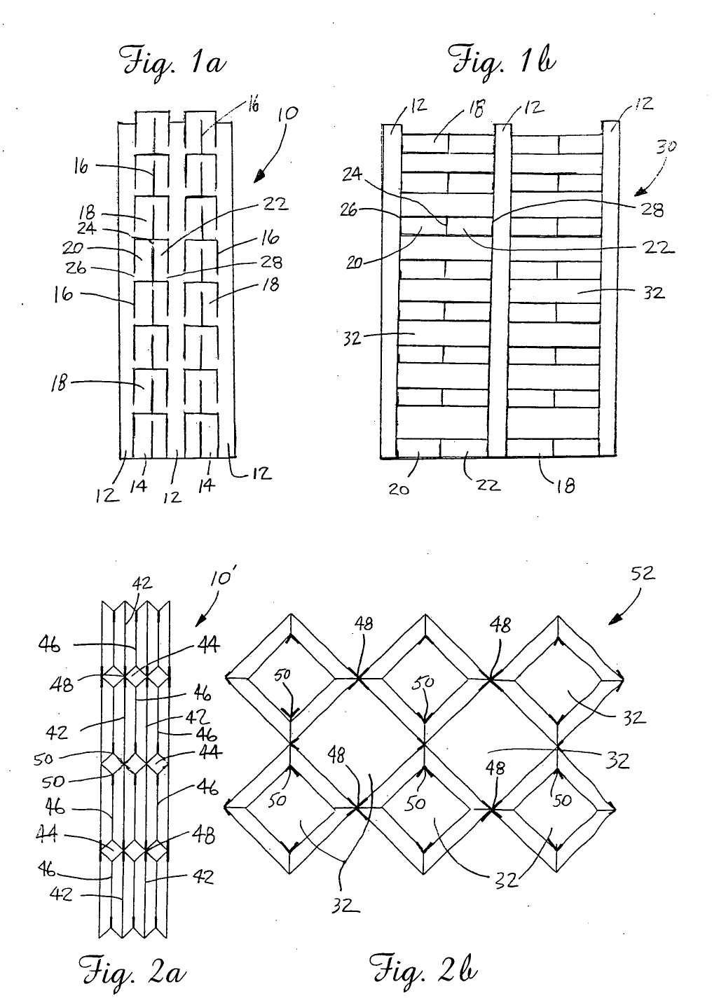

Reference is now made to FIG. 1a showing a honeycomb web precursor 10 of the present invention. The honeycomb web precursor 10 is formed from a body of fibrous material. Suitable fibrous materials include non-woven materials formed of thermoplastic or thermoset fibers, glass fibers, metal fibers, basalt fibers, mineral fibers, carbon fibers, graphite fibers or natural fibers such as cotton, kenaf, and sisal or combinations thereof. Multi-component fibers may also be utilized. Specific examples of polymeric fibers that may be utilized to construct the body include polyolefin fibers, polyamide fibers, polyester fibers, polypropylene fibers, polyvinyl chloride fibers, polyethylene fibers, nylon fibers, rayon fibers, polyethylene terephthalate fibers, polyvinyl acetate fibers, polybutylene terephthalate fibers, melamine fibers, acrylic fibers, visil fibers, aramid fibers and any mixtures thereof. Any suitable materials may be used. Typically, the fibers in the body have a diameter between about 5 and 50 microns and a length between about 12.6 and 75.6 mm.

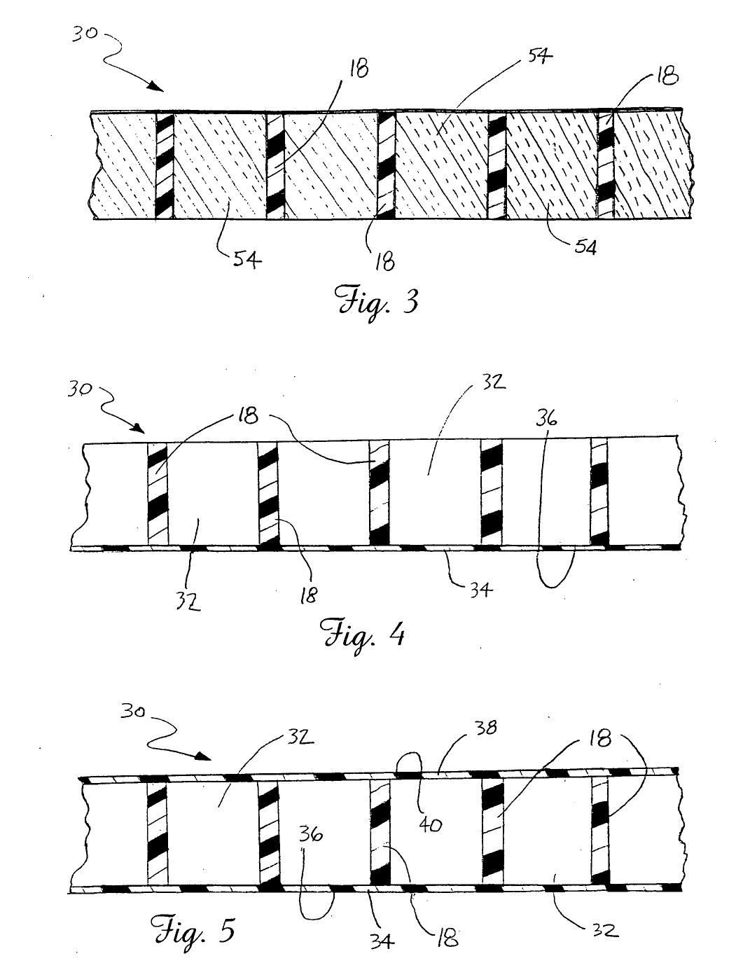

As illustrated in FIG. 1a, the honeycomb web precursor 10 may include alternating inexpansible portions 12 and expansible portions 14. The inexpansible portions are substantially continuous, elongated strips whereas the expansible portions are a series of branched slits 16 that extend completely through the body of the precursor 10. As illustrated, each branched slit is substantially Y shaped and the series of branched slits at least partially nest with one another. Any suitable pattern of cuts which allows the elongation of the web may be employed. As illustrated in FIG. 2a, the inexpansible portions are optional.

As further illustrated in FIGS. 1a and 1b, adjacent branched slits 16 define an expansion rib 18. Each expansion rib 18 includes a first segment 20 and a second segment 22. The first segment 20 is connected end-to-end with the second segment 22 by a first flexible hinge 24. The opposite end of the first segment 20 is connected to an inexpansible portion 12 of the precursor 10 by a second flexible hinge 26. Similarly, a third flexible hinge 28 connects the opposite end of the second segment 22 to another, different inexpansible portion 12. It is also possible to form a honeycomb web precursor 10 that includes a single expansible portion 14 between lateral inexpansible portions. This embodiment is especially useful in creating a web for subsequent processing in for example a die cutting operation.

FIG. 1b shows an expanded honeycomb body 30 and the erected expansion ribs 18. More specifically, each of the expansion ribs 18 is folded along first, second and third flexible hinges 24, 26, 28 so that inexpansible portions 12 are separated and the expansion ribs are erected so as to extend between adjacent inexpansible portions 12. As a result, a series of interstitial openings 32 are provided between adjacent expansion ribs 18 and inexpansible portions 12. Depending upon the size of the branched slits 16 provided in the expansible portions 14 of the honeycomb web precursor 10, the area covered by the geometric pattern of the erected honeycomb web 30 compared to the original area of the honeycomb web precursor 10 can be an increase of about 110 to 500%.

The erected honeycomb web 30 may then be filled with an insulation material 54. An erected honeycomb web 30 filled with thermoplastic fibers may be heat treated above the softening point of the material and then cooled in order to thermally set the panel in the erected shape. An erected honeycomb web 30 filled with an uncured bindered material may be heated to cure the binder to set the panel in the erected shape. An erected honeycomb web 30 filled with precured or unbonded fibers may then be treated with an adhesive such as thermoset resin, thermoplastic powder, epoxy or chemical glue and heated to set the panel.

As seen in FIG. 4, a facing layer 34 may be adhered to a first face 36 of the erected honeycomb web 30. In yet another embodiment, as shown in FIG. 5, a second facing layer 38 may be adhered to a second facing 40 of the erected honeycomb web 30. In either of these embodiments the facing layers 34, 38 are sufficiently rigid to hold the expansion ribs 18 in the expanded or erected position and maintain the insulation material in the interstices 32 of the honeycomb web 30. The first and second facing layers 34, 38 may be formed of any suitable material, for example, natural or polymeric fibrous materials, foils, paper, fiberglass mats, or polymer sheets or films such as ester vinyl acetate, polyvinyl chloride, nylon, rubber and highly filled sheets or films. The facer may also include a reinforced web. It is often preferred to use a vapor permeable facing layer 34 on one side of the panel while using a vapor impermeable facing layer 38 on the opposite side of the panel. One or both facing layers 34, 38 may extend beyond the peripheral edges of the panel 30 to form flanges 34a, 38a that may be used to secure the panel 30 to the item to be insulated, for example to the studs of a wall cavity in a residential structure.

Yet another alternative embodiment is illustrated in FIGS. 2a and 2b. In this embodiment, a honeycomb web precursor 10′ is formed of a fibrous material. In this alternative embodiment of the invention, alternating rows of straight slits 42 and openings 44 with extension slits 46 define a four-way flexible hinge 48 at a convergence of slits 42, 46 and openings 44. Similar to the embodiment shown in FIG. 1a, the embodiment shown in FIG. 2a may be erected by folding the honeycomb web precursor 10′ about the four-way flexible hinges 48 provided at the convergence of adjacent straight slits 42 and openings 44 and the additional flexible hinges 50 provided at opposing corners of alternating openings 44 that do not define four-way flexible hinges 48.

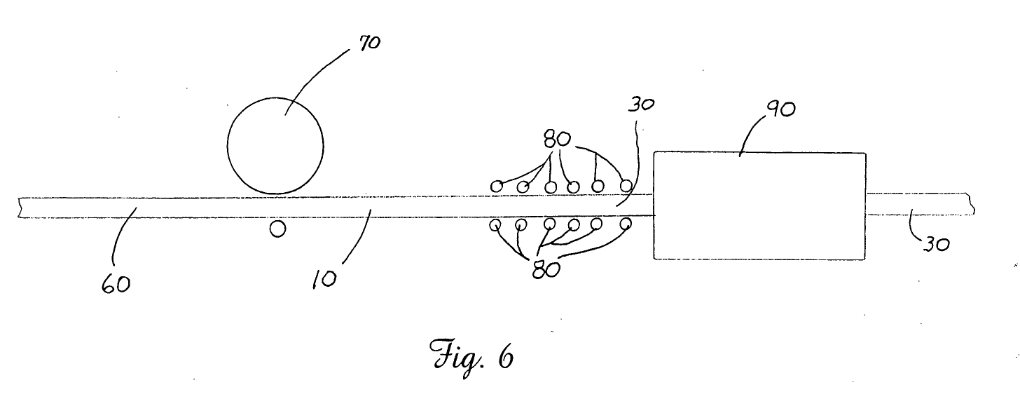

The erected honeycomb web 52 of the embodiment illustrated in FIG. 2b may be held in the erected position by thermally setting the material, prior to the insertion of insulation 54 and the application of any facing layers. An exemplary method of in-line production of the insulative panel of the present invention is schematically illustrated in FIG. 6.

The body of fibrous material 60 may be fed from a roll or directly from a forming station through a rotary die cutter 70 that cuts the nested, branched slits 16 in the expansible portions of the precursor 10. If desired, the precursor 10 may then be advanced through a series of spreader rolls 80 that expand the precursor by folding the expansion ribs 18 open about the hinges 24, 26, 28. The honeycomb web 30 may then be advanced through a filling, setting or laminating device 90. The device 90 typically inserts the insulation material 54 into the interstices and may include a thermal oven or a facing applicator. If an adhesive or binder is used to set the panel 30, the adhesive may be applied during the manufacture of the fibrous material 60 or insulation material, by application of adhesive to the fibrous material 60, the precursor 10, or the insulation panel 30 prior to entering the setting device 90.

In any embodiment of the present invention, the interstitial openings 32 may simply function as air spaces. As shown in FIGS. 4 and 5, the interstices 32 may be filled with fibrous material 54 and sealed with a facer on one or both sides. Suitable insulation materials include bonded loosefill, such Advanced ThermaCube Plus (available from Owens Corning of Toledo, Ohio), unbonded loosefill insulation, such as ProPink (available form Owens Corning of Toledo, Ohio), and cubes, nodules or bundles of fibers of any suitable fibrous material. As shown in FIG. 5, the filling material 54 may be sealed within the interstices 32 by providing a facing layer 34, 38 over each face 36, 40 of the honeycomb webs 30, 52.

The insulation panel 30 has myriad applications including: a batt of thermal or acoustical insulation for use in residential structures or a partition such as a room partition or other structural panel such as a building panel. The insulation panel 30 may be used as an acoustical decoupler, as a stiffener or as a spacer between two or more fibrous webs to be subsequently processed. According to the present invention, the process and product may be utilized to reduce materials used in constructing a panel, partition or the like. The honeycomb web of the present invention reduces both the production costs and the weight of the final product without any significant compromise in product strength.

The insulation panel 30 may also be useful as an acoustical and thermal insulator in a motor vehicle. Some other potential applications in the automotive industry include, but are not limited to, under carpet applications, heat shields, acoustical decouplers for engine sides and interior materials and as a filler material. Potential non-automotive applications for the insulation panel 30 include the appliance industry where the material may be used as a dishwasher blanket, range insulator, oven insulation, clothes washer insulator and clothes dryer insulator, and as acoustical filler materials for wall panels and ceiling tiles.

The foregoing description of the preferred embodiment of the invention has been presented for purposes of illustration and description. It is not intended to be exhaustive or to limit the invention to the precise form disclosed. Obvious modifications or variations are possible in light of the above teachings. For example, while a rotary die cutter 65 is described and illustrated for cutting the branched slits 16; other devices/methods could be utilized. Such devices include, but are not limited to, cutting by water jet, laser and/or die rule.

The embodiments chosen and described provide illustrations of the principles of the invention and practical applications to enable one of ordinary skill in the art to utilize the invention in various embodiments and with various modifications as are suited to the particular uses contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

We claim:

1. An insulation panel, comprising:
a fibrous body having first and second opposed surfaces and first and second opposed edges and a plurality of cuts made in said body and extending from said first opposed surface to said second opposed surface, said fibrous web being extensible to create interstices in said body; and
an insulation material in said interstices.

2. The insulation panel of claim 1, wherein the fibrous body is extensible primarily by bending the fibers around a plurality of flexible hinges.

3. The insulation panel of claim 2, wherein the plurality of cuts comprises a pattern of intersecting cuts which form said flexible hinges.

4. The insulation panel of claim 1, wherein said fibrous body is formed of fibers selected from the group consisting essentially of polyolefin fibers, polyamide fibers, polyester fibers, polypropylene fibers, polyvinyl chloride fibers, polyethylene fibers, nylon fibers, rayon fibers, polyethylene terephthalate fibers, polyvinyl acetate fibers, polybutylene terephthalate fibers, melamine fibers, acrylic fibers, visil fibers, aramid fibers, glass fibers, metal fibers, basalt fibers, mineral fibers, carbon fibers, graphite fibers, cotton fibers, kenaf fibers, sisal fibers, and mixtures thereof.

5. The insulation panel of claim 1, wherein said insulation material is formed of fibers selected from the group consisting essentially of polyolefin fibers, polyamide fibers, polyester fibers, polypropylene fibers, polyvinyl chloride fibers, polyethylene fibers, nylon fibers, rayon fibers, polyethylene terephthalate fibers, polyvinyl acetate fibers, polybutylene terephthalate fibers, melamine fibers, acrylic fibers, visil fibers, aramid fibers, glass fibers, metal fibers, basalt fibers, mineral fibers, carbon fibers, graphite fibers, cotton fibers, kenaf fibers, sisal fibers and mixtures thereof.

6. The insulation panel of claim 5, wherein the fibers are selected from the group consisting essentially of staple fibers, chopped fibers, bonded glasswool fibers, unbonded glasswool fibers and mixtures thereof.

7. The insulation panel of claim 5, wherein the fibers are selected from the group consisting essentially of single component and multi-component fibers.

8. The insulation panel of claim 1, further comprising:
a first facer on said first surface, wherein said first facer is formed of a vapor permeable material.

9. The insulation panel of claim 8, further comprising:
a second facer on said second surface, wherein said second facer is formed of a vapor barrier material.

10. A method of forming an insulative panel, comprising the steps of:
providing a fibrous body having first and second opposed surfaces and first and second opposed edges;
forming a plurality of cuts in said body, said cuts extending from said first opposed surface to said second opposed surface;
extending said fibrous body to create interstitial openings; and
filling said interstitial openings with an insulation material.

11. The method of forming an insulative panel of claim 10, wherein the step of forming a plurality of cuts comprises cutting an intersecting pattern to form a plurality of flexible hinges.

12. The method of forming an insulative panel of claim 11, wherein the pattern is selected from the group consisting of slits, holes and combinations thereof.

13. The method of forming an insulative panel of claim 10, wherein the step of filling said interstitial openings comprises the step of inserting fibers selected from the group consisting essentially of polyolefin fibers, polyamide fibers, polyester fibers, polypropylene fibers, polyvinyl chloride fibers, polyethylene fibers, nylon fibers, rayon fibers, polyethylene terephthalate fibers, polyvinyl acetate fibers, polybutylene terephthalate fibers, melamine fibers, acrylic fibers, visil fibers, aramid fibers, glass fibers, metal fibers, basalt fibers, mineral fibers, carbon fibers, graphite fibers, cotton fibers, kenaf fibers, sisal fibers, staple fibers, chopped fibers, bonded glasswool fibers, unbonded glasswool fibers, single component, multi-component fibers and mixtures thereof.

14. The method of forming an insulative panel of claim 10, further comprising the step of:
applying an adhesive to the insulation material.

15. The method of forming an insulative panel of claim 10, further comprising the step of:
applying a facer to the first surface of said insulative panel, wherein said facer is selected from the group consisting of vapor permeable material and vapor barrier material.

16. The method of forming an insulative panel of claim 10, further comprising the steps of:
applying a vapor permeable facer to the first surface; and
applying a vapor barrier facer to the second surface.

17. An insulation panel, comprising:
a fibrous body having first and second opposed surfaces and first and second opposed edges and a plurality of cuts in said body extending from said first opposed surface to said second opposed surface, said fibrous body being extended to create interstices in said body;
an insulation material in said interstices;
a first facer on said first opposed surface; and
a second facer on said second opposed surface.

18. The insulation panel of claim 17, further comprising:
facer flanges on at least one of said opposed edges.

19. The insulation panel of claim 17, wherein said fibrous body is formed of fibers selected from the group consisting essentially of polyolefin fibers, polyamide fibers, polyester fibers, polypropylene fibers, polyvinyl chloride fibers, polyethylene fibers, nylon fibers, rayon fibers, polyethylene terephthalate fibers, polyvinyl acetate fibers, polybutylene terephthalate fibers, melamine fibers, acrylic fibers, visil fibers, aramid fibers, glass fibers, metal fibers, basalt fibers, mineral fibers, carbon fibers, graphite fibers, cotton fibers, kenaf fibers, sisal fibers and mixtures thereof.

20. The insulation panel of claim 17, wherein said insulation material is formed of fibers selected from the group consisting essentially of polyolefin fibers, polyamide fibers, polyester fibers, polypropylene fibers, polyvinyl chloride fibers, polyethylene fibers, nylon fibers, rayon fibers, polyethylene terephthalate fibers, polyvinyl acetate fibers, polybutylene terephthalate fibers, melamine fibers, acrylic fibers, visil fibers, aramid fibers, glass fibers, metal fibers, basalt fibers, mineral fibers, carbon fibers, graphite fibers, cotton fibers, kenaf fibers, sisal fibers and mixtures thereof.
